(19) United States
(12) Patent Application Publication
(10) Pub. No.: US 2018/0217005 A1
(43) Pub. Date: Aug. 2, 2018

(54) DEVICE AND COMPONENTS OVERHEATING EVALUATION

(71) Applicant: Pervacio Inc, Irving, TX (US)

(72) Inventor: Sanjay Kanodia, Irving, TX (US)

(21) Appl. No.: 15/884,866

(22) Filed: Jan. 31, 2018

Related U.S. Application Data
(60) Provisional application No. 62/453,648, filed on Feb. 2, 2017.

(51) Int. Cl. G01K 3/02; G06F 9/30; G01K 1/02; G01K 1/12

(52) U.S. Cl. CPC G01K 3/02; G06F 9/30003; G01K 1/022; G08B 5/22; G01K 1/026; G01K 1/028; G01K 1/12

(57) ABSTRACT

A method for measuring temperature of a device includes measuring temperatures for each of a plurality of components or zones of the device and combining the temperatures measured into a device total temperature. A system for measuring temperature of a device includes a processor and a non-transitory memory component operatively coupled with the processor. The non-transitory memory component has, recorded thereto, computer readable instructions configured to cause the processor to measure temperatures for each of a plurality of components or zones of the device and combine the temperatures measured into a device total temperature.

### CROSS-REFERENCE TO RELATED APPLICATIONS

This application claims the priority benefit of U.S. Provisional Application No. 62/453,648 filed on Feb. 2, 2017 which is incorporated herein by reference in its entirety.

### SUMMARY

The disclosure seeks to provide a system for measuring temperature of a device. The system includes a processor and a non-transitory memory component operatively coupled with the processor and having, recorded thereto, computer readable instructions configured to cause the processor to measure temperatures for each of a plurality of components of the device and combine the temperatures measured for the plurality of components into a device total temperature.

The disclosure also seeks to provide a method for evaluating overheating of a device. The method includes obtaining a plurality of temperature measurements for the device, combining the obtained temperature measurements into a device total temperature and issuing an overheating notification when the device total temperature exceeds a threshold temperature.

The disclosure further seeks to provide a system for evaluating overheating of a device. The system includes a database containing threshold temperatures for a plurality of devices, a processor and a non-transitory memory component operatively coupled with the processor. The non-transitory memory component has, recorded thereto, computer readable instructions configured to cause the processor to obtain a plurality of temperature measurements for the device, combine the obtained temperature measurements into a device total temperature, retrieve a threshold temperature associated with the device from the database and issue an overheating notification when the device total temperature exceeds the threshold temperature associated with the device.

Additionally, the disclosure seeks to provide a non-transitory computer-readable storage medium. The non-transitory computer-readable storage medium, has, recorded thereto, computer readable instructions configured to evaluate overheating of a device, wherein the instructions, when executed, cause one or more processors to obtain a plurality of temperature measurements for the device, combine the temperature measurements obtained into a device total temperature and issue an overheating notification when the device total temperature exceeds the threshold temperature associated with the device.

### BRIEF DESCRIPTION OF THE FIGURES

The summary above, as well as the following detailed description of illustrative embodiments, is better understood when read in conjunction with the appended drawings. For the purpose of illustrating the disclosure, example constructions of the disclosure are shown in the drawings. However, the disclosure is not limited to specific methods and instrumentalities disclosed herein. Moreover, those having ordinary skill in the art will understand that the drawings are not to scale. Wherever possible, like elements have been indicated by identical numbers.

Embodiments of the disclosure will now be described, by way of example only, with reference to the following diagrams wherein:

FIG. 1 illustrates a flow of an example method for measuring temperature of a device.

FIG. 2 schematically illustrates various components of a system for measuring temperature of a device or a system for evaluating overheating of a device, in accordance with embodiments of the disclosure.

FIG. 3 illustrates an example user interface presented to an example display of an example device in accordance with embodiments of the disclosure.

### DETAILED DESCRIPTION

The following detailed description illustrates embodiments of the disclosure and manners by which they can be implemented. Although the best mode of carrying out the disclosure has been described, those skilled in the art would recognize that other embodiments for carrying out or practicing the disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the disclosure provide a system for determining a temperature of a device from the temperature of components of the device. Additionally, methods are disclosed for measuring temperature of a device and evaluating device overheating. Embodiments of the disclosure substantially eliminate, or at least partially address, problems in the prior art, enabling a user to determine an overall or total temperature of a device and evaluate overheating and/or potential overheating without needing a separate, an external temperature sensor such as an infrared thermometer. Overheating may imply an unhealthy device possibly having an electronics malfunction or a battery malfunction.

Additional aspects, advantages, features and objects of the disclosure will be made apparent from the drawings and the detailed description of the illustrative embodiments construed in conjunction with the appended claims that follow. It will be appreciated that features of the disclosure are susceptible to being combined in various combinations without departing from the scope of the disclosure as defined by the appended claims.

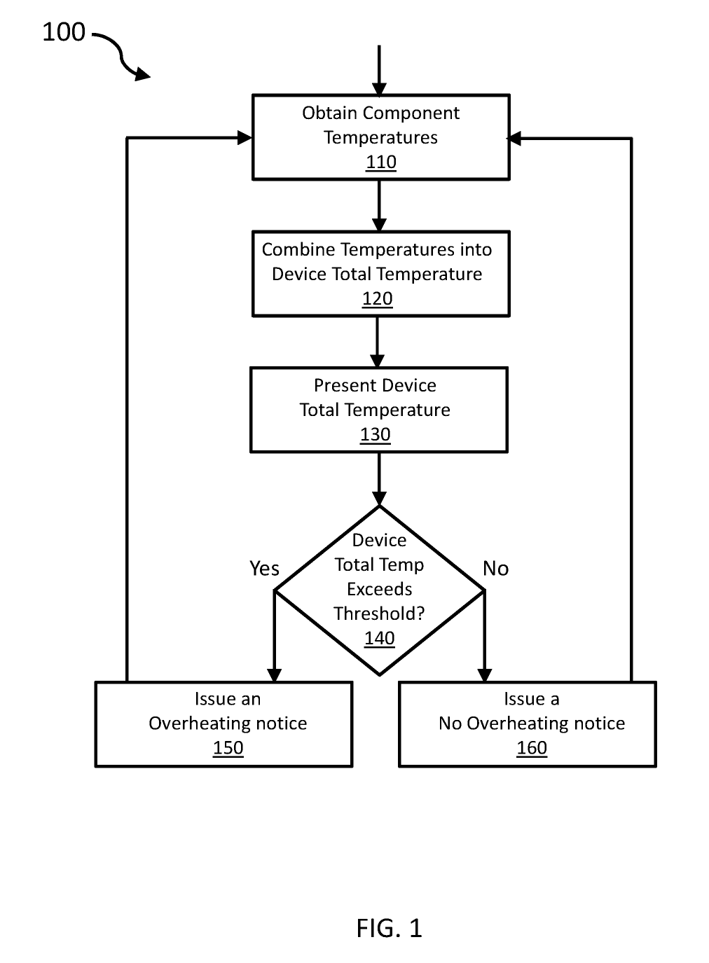

FIG. 1 illustrates a flow of an example method for measuring temperature of a device. The temperature of any of a variety of components or zones of the device are measured or otherwise obtained at 110. For example, temperatures may be obtained for a global positioning system component, a wireless interface component, a central processing component, a graphics processing component, a network interface component, a power source component or a combination of these.

In an example implementation, the temperatures of the device components are requested. In another example implementation, the temperatures of zones of the device are requested, for example, as surface temperatures. For example, a processor of the device may request the temperatures component or zone temperatures from an operating system of the device, a memory component of the device or any combination of these.

In an example stress test usable with or as part of disclosed systems and methods, component or zone temperatures may be obtained by applying a load to each of the components. For example, before obtaining component or zone temperatures, videos and/or music may be played, data may be recorded, transmissions may be sent, etc. for a duration sufficient to change the temperature of one or more components or zones of the device being tested. Components may be loaded individually at different times or may be loaded simultaneously.

With temperatures obtained for each of a plurality of components or zones of the device, the temperatures obtained for the plurality of components or zones are combined into a device total temperature at 120. Combining the component temperatures may employ machine learning or other learning with a computer, may include forming a linear regression model or a combination of these.

The device total temperature derived from temperatures of the device components or zones may be presented with/on an output of the device at 130, for example, in the form of a computer interface provided to a display of the device or a display of another data processing unit.

According to an example evaluation of device overheating, device total temperature may be compared with a threshold temperature to determine, at 140, whether the device total temperature exceeds the threshold temperature. A threshold temperature may be obtained from any of a variety of sources including a database communicatively coupled with the device through a communications network. Frequently, device and component manufactures establish threshold temperatures. In an example, threshold temperatures are established by a user of the overheating system and/or service and are based upon specifications from original equipment manufacturers of the device being evaluated and/or components of thereof.

When device total temperature is determined to exceed the established threshold, an excessive temperature message/warning or an Overheating Notification may be issued at 150. In a further example, a ‘No Overheating’ notification may be issued at 160 to reflect there is no overheating of the device when the device temperature is determined to not exceed the established threshold. For example, the ‘No Overheating’ notification may be issued when the device total temperature is less than or equal to the established threshold.

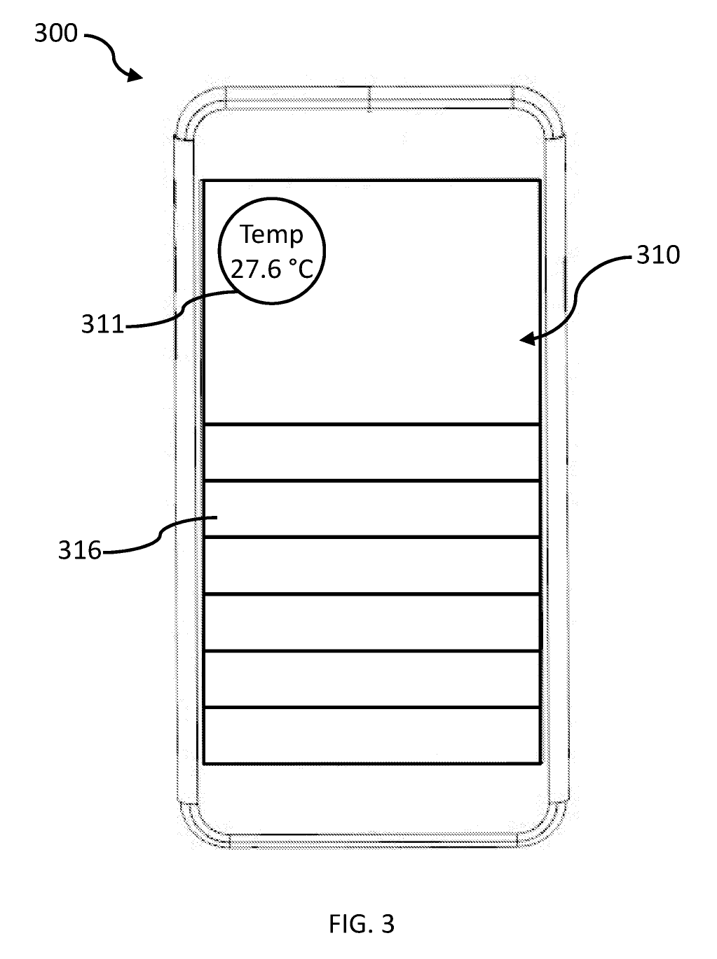

A message, warning or notification issued reflecting the disposition of the device total temperature relative to the threshold may take any of a variety of forms including audible form, visual form, haptic form or any combination of these. In an example, visual feedback may be a combination of text and colors according to a color-coded messaging scheme (see FIG. 3).

In another example method for determining temperature of a device, a thermal camera is used to record surface temperatures of the device and the recorded surface temperatures are processed into a device total temperature by a computing device. Device total temperature and/or recorded surface temperatures may be presented to a graphical user interface on the device or used in a comparison with a threshold temperature.

In another example method for determining temperature of a device, thermal sensors and one or more systems on chips are used to record surface temperatures of the device and the recorded surface temperatures are processed into a device total temperature. Device total temperature and/or recorded surface temperatures may be presented to a graphical user interface on the device.

Embodiments of the disclosure provide a computer program product that includes a non-transitory or non-transient computer-readable storage medium storing computer-executable code configured to cause one or more processors to perform actions described in conjunction with the above methods as described with reference to FIG. 1. Actions performed by the one or more processors executing the code include but are not limited to obtaining temperatures for a plurality of components or zones of the device, combining the temperatures obtained for the plurality of components or zones into a device total temperature, determining whether the device total temperature exceeds a threshold temperature and issuing a notice as to whether the device is overheating or is predicted to overheat. As actions of the disclosed methods may be provided in different sequences, so the computer-executable code may be configured to provide a service having a different sequence of actions from those illustrated in FIG. 1. In some examples, the code may be downloaded from a software application store, for example, from an “App store”, to a device.

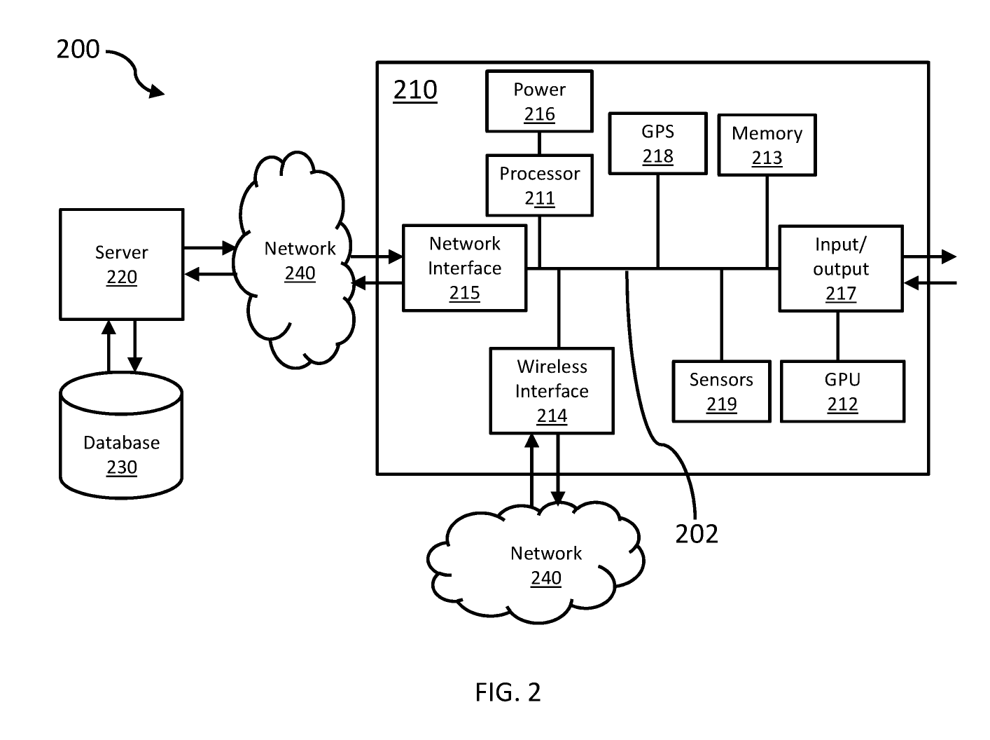

FIG. 2 is a schematic illustration of various components of a system 200 for measuring temperature of a device, in accordance with an embodiment of the disclosure. System 200 includes a test device 210 as well as a server 220 operatively coupled with a database 230.

Test device 210, which may be a mobile device or a mobile computing device, includes a processor 211 and a non-transitory memory component 213 operatively coupled with processor 211. Non-transitory memory component 213 has, recorded thereto, computer readable instructions configured to cause processor 211 to measure or otherwise obtain temperatures for each of a plurality of components of the device and combine the temperatures measured for the plurality of components into a device total temperature. The computer readable instructions may be recorded to memory 213, for example, after download from server 220 over a communications network such as network 240 or over a wire or may be recorded to memory 213 at time of manufacture or distribution.

Device 210 is coupled in communication with server 220 via a communication network such as network 240. Communication network 240 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

System 200 may be implemented in various ways, depending on various possible scenarios. In one example scenario, system 200 may be implemented, in part, by way of a spatially collocated arrangement of server 220 and database 230. In another example scenario, system 200 may be implemented by way of a spatially distributed arrangement of server 220 and database 230 coupled mutually in communication via a communication network. In yet another example scenario, server 220 and database 230 may be implemented via cloud computing services.

Examples of devices usable with or as part of disclosed systems and methods as device 210 and suitable for testing as herein disclosed include, but are not limited to, mobile phones, smart telephones, Mobile Internet Devices (MIDs), tablet computers, Ultra-Mobile Personal Computers (UMPCs), phablet computers, Personal Digital Assistants (PDAs), wearable computing devices such as smart watches, web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

System 200 is suitable for implementing various methods for determining device total temperature from temperatures of one or more components. In order to implement a system for determining device total temperature, server 220 may provide a service to the devices, while database 230 may store data related to device total temperatures, component temperatures, zone temperatures or a combination of these.

Optionally, devices may access server 220 to download one or more computer program products associated with the temperature determination/evaluation service. In one embodiment, system 200 is arranged in a manner that its functionality is implemented partly in device 210 and partly in server 220. In another embodiment, system 200 is arranged in a manner such that its functionality is implemented substantially in the device 210 by way of the downloaded applications or computer program products. In such an implementation, device 210 may be coupled to server 220 periodically or randomly from time to time, for example, to receive updates from server 220 and/or to upload status or collected data thereto.

Users such as consumers, information technology resource providers, retailers and original equipment manufacturers associated with the devices use the temperature determination service and associated systems and methods.

In an embodiment of the disclosure, device 210 and/or server 220 may substantially continuously record and update changes in database 230.

Furthermore, the temperature determination service can be offered free of cost or can be a paid service that has a subscription-based billing or a transaction-based billing, such as pay-per-use and pay-per-feature.

It is to be understood that the specific description for system 200 is provided as an example and is not to be construed as limiting the system to specific numbers, types, or arrangements of data processing units, mobile computing devices, servers, databases and communication networks. A person skilled in the art will recognize many variations, alternatives, and modifications of embodiments of the disclosure.

Test device 210 includes, but is not limited to, a memory 213, a computing hardware such as a processor 211, a wireless interface component 214, a network interface component 215, a graphics processing unit 212, I/O devices 217, a global positioning system 218, a configuration of sensors 219 and a system bus 202 that operatively couples various components including memory 213, processor 211, wireless interface component 214, network interface component 215, graphics processing unit 212, I/O devices 217, global positioning system 218 and sensors 219. I/O devices 217 include a display screen for presenting graphical images to a user. Test device 210 also includes a power source 216 for supplying electrical power to the various components. Power source 216 may, for example, include a rechargeable battery.

Memory 213 optionally includes non-removable memory, removable memory, or a combination thereof. Non-removable memory, for example, includes Random-Access Memory (RAM), Read-Only Memory (ROM), flash memory, or a hard drive. Removable memory, for example, includes flash memory cards, memory sticks, or smart cards.

Memory 213 stores applications including, for example, parts of a computer program product associated with the disclosed overheating evaluation service provided by system 200. Executing the computer program product on processor 211 results, in part, in generating and rendering a graphical user interface on the display screen in accordance with I/O devices 217. The graphical user interface is configured to facilitate user interactions with the device and components temperature evaluation system and associated services. Further, processor 211 and the interface may be configured for displaying or otherwise presenting images representing one or more heat maps and/or evaluations of a device being tested such as device 210. For example, an excessive temperature message/warning, an Overheating Notification, a ‘No Overheating’ notification or a combination of these may be displayed. Output to the display may include text, colors, shapes or a combination of these.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen. Various functions of the device and components temperature evaluation system and service may be accessed and or controlled through the tactile inputs.

Additionally or alternatively, I/O devices 217 may include a mouse or a joystick operable to receive inputs corresponding to clicking, pointing, and/or moving a pointer object on a graphical user interface. I/O devices 217 may also include a keyboard operable to receive inputs corresponding to pushing certain buttons on the keyboard. Additionally, I/O devices 217 may also include a microphone for receiving an audio input from the user, and a speaker for providing an audio output to the user.

Moreover, sensors 219 may include one or more of: a camera, an accelerometer, a magnetometer, a pressure sensor, a temperature sensor, a gyroscopic sensor or a timer.

Sensors 219 may be used to measure and collect data related to characteristics of a device being tested such as individual component or zone temperatures. Additionally, outputs generated by sensors 219 may, for example, be indicative of surroundings of a user of device 210. In some examples, a computer program product may be interfaced with sensors 219. When executed on processor 211, the computer program product is configured to resolve and integrate outputs of sensors 219 into useful information about device total temperature or device overheating predictions or a combination of these. Temperatures of the plurality of components may be requested from memory component 213 (if previously stored) directly from sensors 219 or a combination of these. In an example, sensors 219 may be operatively coupled directly and individually to each of the other components of device 210 rather than through bus 202.

Moreover, the computer program product, when executed on processor 211, is optionally coupled to memory 213, and is configured to record and therein update data collected and/or measured by sensors 219. Additionally, the computer program product, when executed on processor 211, may store output from processor 211 in memory 213. Such output may, for example, include at least one of device total temperature or a device overheating prediction.

Furthermore, network interface 215 optionally enables device 210 to upload output from processor 211, such as that stored to memory 213, to server 220, for example, via communication network 240. Additionally, network interface 215 may enable device 210 to access server 220 to update the computer program product and/or download one or more new computer program products associated with the temperature evaluation system and/or service. Moreover, network interface 215 and/or wireless interface 214 optionally allow device 210 to communicate with other devices and data processing units, for example, communication network 240.

Computer readable instructions of the computer program product are optionally configured to cause a processor to apply a load to each of a plurality of components during a stress test. For example, the program product may cause processor 211 to play videos or music with input/output 217, record data with memory 213, receive/transmit signals with network interface 215, wireless interface 214, GPU 212 or GPS 218 for a duration sufficient to change temperature of one or more components or zones of the device being tested.

Computer readable instructions of the computer program product are optionally configured to read values of thermal sensors that are original equipment of and internal to the device being measured. In an example, thermal sensor values are read through the device operating system using APIs. Example code for the reading thermal sensor values may resemble:
temperature=readTemperature(“/sys/class/thermal/thermal_zone”+String.valueOf(i)+“/temp”);

In an example, the computer program product includes one or more modules such as a composer. When activated by processor 211, the composer is configured to process individual component temperatures of the device being tested. Processing individual component temperatures of the device, includes, but is not limited to producing one or more final device temperatures. The composer may combine device component temperatures in any of a variety of ways including but not limited to forming a linear regression model representing, describing or otherwise expressing a device total temperature.

In an example, the linear regression model may take the form:

$$Y = {β}_{0} + {\sum }_{i = 1}^{n} {β}_{i} {X}_{i} + ϵ$$

Where Xᵢ are the individual component or zone temperatures at a given time and Y is the device total temperature at that time. βᵢ are individual coefficients improved over time with machine learning. Feature normalization and gradient descent methods may be used in the machine learning techniques to improve the accuracy of the predicted value based upon the individual coefficients.

The computer readable instructions are optionally configured to cause the processor to determine whether the device total temperature exceeds a threshold temperature. In an example, when the threshold temperature has been exceeded, some type of alert, warning, message or indication may be issued to a user of the device, for example, through a user interface.

The computer readable instructions are optionally configured to cause the processor to present the device total temperature with/on an output of the device for example in the form of a computer interface provided to a display of the device or a display of another data processing unit.

With a device total temperature computed, processor 211 is configured to issue an evaluation of the total temperature of the device being tested in accordance with user-configured standards. For example, the evaluation issued by the processor may indicate the device total temperature exceeds an established threshold, may include an Overheating Notification, may include a ‘No Overheating’ notification indicating a device total temperature is less than or equal to the established threshold or a combination of these.

FIG. 2 is merely an example, which should not unduly limit the scope of the claims herein. It is to be understood that the specific designation for device 210 is provided as an example and is not to be construed as limiting device 210 to specific numbers, types, or arrangements of modules and/or components of device 210. A person skilled in the art will recognize many variations, alternatives, and modifications of embodiments of the disclosure.

FIG. 3 illustrates an example user interface 310 for presentation to a display of a mobile computing device 300 in accordance with an embodiment of the disclosure. In an example, device 300 may be implemented as device 210 as part of system 200. The example user interface 310 presents a device total temperature icon 311 established by combing temperatures of a plurality of components or zones of the device 300. The example user interface 310 may be provided to a display of the device or to the display of another data processing unit. Different ranges of device total temperatures presented to the user interfaces as icon 310 may be coded or otherwise associated to different colors. For example, a green color may be displayed when a device total temperature is safely below a threshold temperature, a yellow color may be displayed when a device total temperature within a predefined range below the threshold temperature, and a red color may be displayed when a device total temperature exceeds a threshold temperature. Graphics 316 may reflect one or more other conditions of device 300 or components thereof.

Embodiments of the disclosure are susceptible to being used for various purposes including, though not limited to, enabling users to determine a total temperature of a device without needing a separate temperature sensor such as an infrared thermometer.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A method for evaluating overheating of a device, comprising:
obtaining a plurality of temperature measurements for the device;
combining the obtained temperature measurements into a device total temperature; and
issuing an overheating notification when the device total temperature exceeds a threshold temperature.

2. The method as set forth in claim 1, wherein obtaining the temperature measurements further comprises obtaining temperature measurements for a plurality of components of the device.

3. The method as set forth in claim 1, wherein obtaining the temperature measurements further comprises reading temperature measurements from heat sensors configured to individually measure temperature of a plurality of components of the device.

4. The method as set forth in claim 1, wherein obtaining the temperature measurements further comprises reading one or more surface temperatures.

5. The method as set forth in claim 1, wherein obtaining the temperature measurements further comprises applying a load to each of a plurality of components of the device.

6. The method as set forth in claim 1, wherein combining the obtained temperature measurements further comprises forming a linear regression model representing the device total temperature.

7. The method as set forth in claim 6, further comprising determining coefficients of the linear regression model with one or more machine learning algorithms.

8. A system for evaluating overheating of a device, comprising:
a database containing threshold temperatures for a plurality of devices;
a processor;
a non-transitory memory component operatively coupled with the processor and, having recorded thereto, computer readable instructions configured to cause the processor to:
obtain a plurality of temperature measurements for the device being evaluated;
combine the obtained temperature measurements into a device total temperature;
retrieve from the database, a threshold temperature associated with the device being evaluated; and
issue an overheating notification when the device total temperature exceeds a threshold temperature associated with the device being evaluated.

9. The system as set forth in claim 8, wherein the computer readable instructions are configured to cause the processor to obtain the temperature measurements by obtaining temperature measurements for a plurality of components of the device.

10. The system as set forth in claim 8, further comprising:
a plurality of heat sensors configured to individually measure temperature of a plurality of components of the device; and
wherein the computer readable instructions are configured to cause the processor to obtain the plurality of temperature measurements by reading temperature measurements of the plurality of heat sensors.

11. The system as set forth in claim 8, wherein the computer readable instructions are further configured to cause the processor to obtain the temperature measurements by reading a plurality of surface temperatures.

12. The system as set forth in claim 8, wherein the computer readable instructions are configured to cause the processor to apply a load to each of a plurality of components of the device.

13. The system as set forth in claim 8, wherein the computer readable instructions are configured to cause the processor to form a linear regression model representing the device total temperature.

14. The system as set forth in claim 13, wherein the computer readable instructions are configured to cause the processor to determine coefficients of the linear regression model with one or more machine learning algorithms.

15. A non-transitory computer-readable storage medium, having recorded thereto, computer readable instructions configured to evaluate overheating of a device, wherein the instructions, when executed, cause one or more processors to:
obtain a plurality of temperature measurements for the device;
combine the obtained temperature measurements into a device total temperature; and
issue an overheating notification when the device total temperature exceeds a threshold temperature associated with the device.

16. The non-transitory computer-readable storage medium as set forth in claim 15, wherein the computer readable instructions are configured to cause the processor to obtain the temperature measurements by obtaining temperature measurements for a plurality of components of the device.

17. The non-transitory computer-readable storage medium as set forth in claim 15, wherein the computer readable instructions are configured to cause the processor to obtain the plurality of temperature measurements by reading temperature measurements of a plurality of heat sensors configured to individually measure temperature of a plurality of components of the device.

18. The non-transitory computer-readable storage medium as set forth in claim 15, wherein the computer readable instructions are further configured to cause the processor to obtain the temperature measurements by reading a plurality of surface temperatures.

19. The non-transitory computer-readable storage medium as set forth in claim 15, wherein the computer readable instructions are further configured to cause the processor to apply a load to each of the plurality of components.

20. The non-transitory computer-readable storage medium as set forth in claim 15, wherein the computer readable instructions are further configured to cause the processor to form a linear regression model representing the device total temperature.

21. The non-transitory computer-readable storage medium as set forth in claim 20, wherein the computer readable instructions are further configured to cause the processor to determine coefficients of the linear regression model with one or more machine learning algorithms.

22. A system for measuring temperature of a device, comprising:
a processor; and
a non-transitory memory component operatively coupled with the processor and having, recorded thereto, computer readable instructions configured to cause the processor to measure temperatures for each of a plurality of components of the device and combine the temperatures measured for the plurality of components into a device total temperature.
